(19) United States
(12) Patent Application Publication
(10) Pub. No.: US 2018/0184409 A1
(43) Pub. Date: Jun. 28, 2018

(54) METHODS OF TRIGGERING SIMULTANEOUS MULTI-USER UPLINK AND DOWNLINK OFDMA TRANSMISSIONS FOR FULL- DUPLEX COMMUNICATIONS

(71) Applicant: INTEL CORPORATION, Santa Clara, CA (US)

(72) Inventors: Alexander W. MIN, Portland, OR (US); Minyoung PARK, Portland, OR (US); Shu-Ping YEH, New Taipei City (TW); Ping WANG, Santa Clara, CA (US)

(21) Appl. No.: 15/389,839

(22) Filed: Dec. 23, 2016

(51) Int. Cl. H04W 72/04; H04L 5/00

(52) U.S. Cl. CPC H04W 72/0406; H04W 84/12; H04L 5/0007

(57) ABSTRACT

The 802.11ax Trigger Frame conveys information for solicited MU UL OFDM(A) transmission information. A full-duplex-capable AP can initiate another DL frame transmission(s) during the UL transmission. However, non-UL-solicited STAs may enter a low-power sleep state right after a Trigger Frame reception, and thus cannot receive the full-duplex DL transmission from the AP. Therefore, to enable OFDMA-based full-duplex communication, the AP needs to explicitly announce both scheduled UL and DL transmission(s) in the Trigger Frame.

### TECHNICAL FIELD

An exemplary aspect is directed toward communications systems. More specifically an exemplary aspect is directed toward wireless communications systems and even more specifically to wireless networks and full-duplex communications. Even more particularly, an exemplary aspect is directed toward trigger-based multi-user uplink OFDMA PPDU transmissions.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute of Electronical and Electronics Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an IEEE 802.11ax Trigger Frame format;

FIG. 2 illustrates an exemplary communication environment with UL and DL communications;

FIG. 3 illustrates an exemplary full-duplex Trigger Frame based communications with simultaneous Multi-User (MU) UL and DL transmissions (HD: Half-Duplex, FD: Full-Duplex);

FIG. 4 illustrates a proposed Trigger Frame format for full-duplex OFDMA communications;

FIG. 5 illustrates an AP sending a Full-Duplex Trigger Frame (FD-TF) to schedule simultaneous full-duplex UL and DL OFDMA transmissions using a fixed MCS for the entire DL A-MPDU transmissions regardless of the presence/absence of the interference from the UL OFDMA transmissions or vice versa;

FIG. 6 illustrates a A-MPDU frame format;

FIG. 7 illustrates an exemplary A-MPDU sub-frame format

FIG. 8 illustrates exemplary proposed A-MPDU transmission behaviour, wherein the MPDU delimiter of the nth A-MPDU sub-frame indicates that the transmitter will use MCS index p from the next A-MPDU sub-frame transmission;

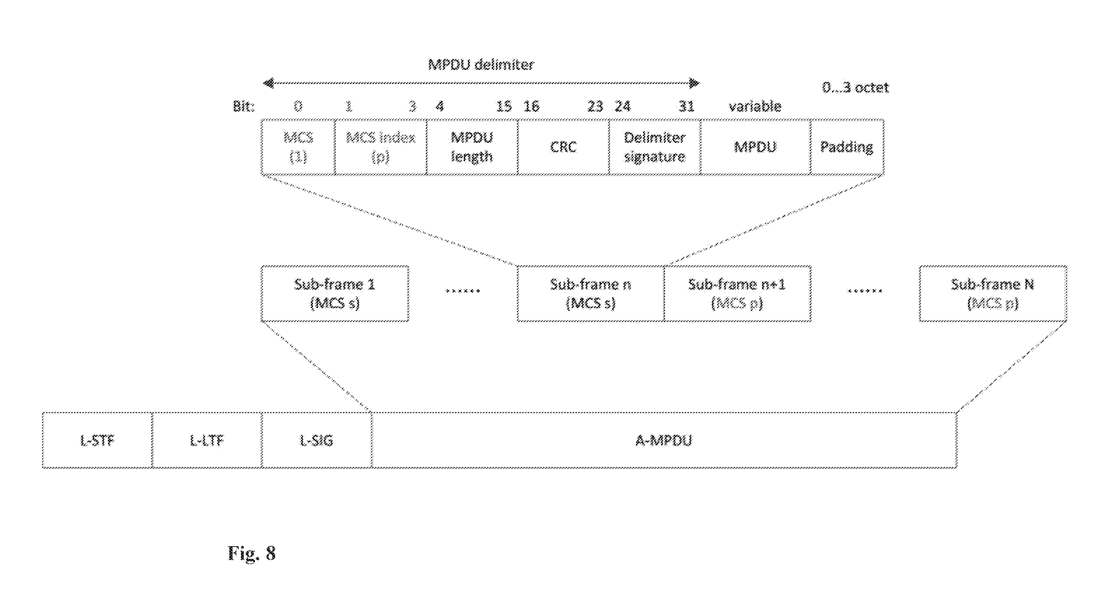

FIG. 9 illustrates a Full-Duplex Trigger Frame format with two MCS indexes for the UL STA's A-MPDU transmission in the presence and absence of AP's DL OFDM(A) transmissions;

FIG. 10 illustrates an example in which the AP may want to define more than one MCS changes during DL OFDM(A) transmission depending on the timing of the start and end of the scheduled UL OFDM(A) transmission;

FIG. 11 illustrates a block diagram of components for performing the techniques disclosed herein;

FIG. 12 is a flowchart illustrating an exemplary method for AP operation in accordance with an exemplary embodiment;

FIG. 13 is a flowchart illustrating an exemplary method for STA or receiver operation in accordance with an exemplary embodiment;

FIG. 14 is a flowchart illustrating an exemplary method for AP operation in accordance with an exemplary embodiment; and

FIG. 15 is a flowchart illustrating an exemplary method for STA or receiver operation in accordance with an exemplary embodiment.

### DESCRIPTION OF EMBODIMENTS

Full-duplex communication has been recognized as a promising technology that can mitigate the spectrum scarcity problem caused by exponentially increasing mobile data traffic, services and applications. Full-duplex communication can double the spectrum efficiency (compared to the conventional half-duplex communications) by allowing wireless radios to simultaneously transmit and receive data on the same frequency band using self-interference cancellation (SIC) technologies in analog RF (Radio Frequency) circuitry and digital signal processing. Full-duplex is one of the candidate technologies for next-gen Wi-Fi systems beyond IEEE 802.11 ax.

OFDMA (Orthogonal Frequency Division Multiple Access) is another promising technology that can significantly improve spectrum efficiency by allowing multiple stations (STAs) to simultaneously transmit data to (or receive data from) a Wi-Fi access point (AP). The draft IEEE 802.11ax standard supports both multi-user (MU) uplink (UL) and downlink (DL) OFDMA frame transmissions.

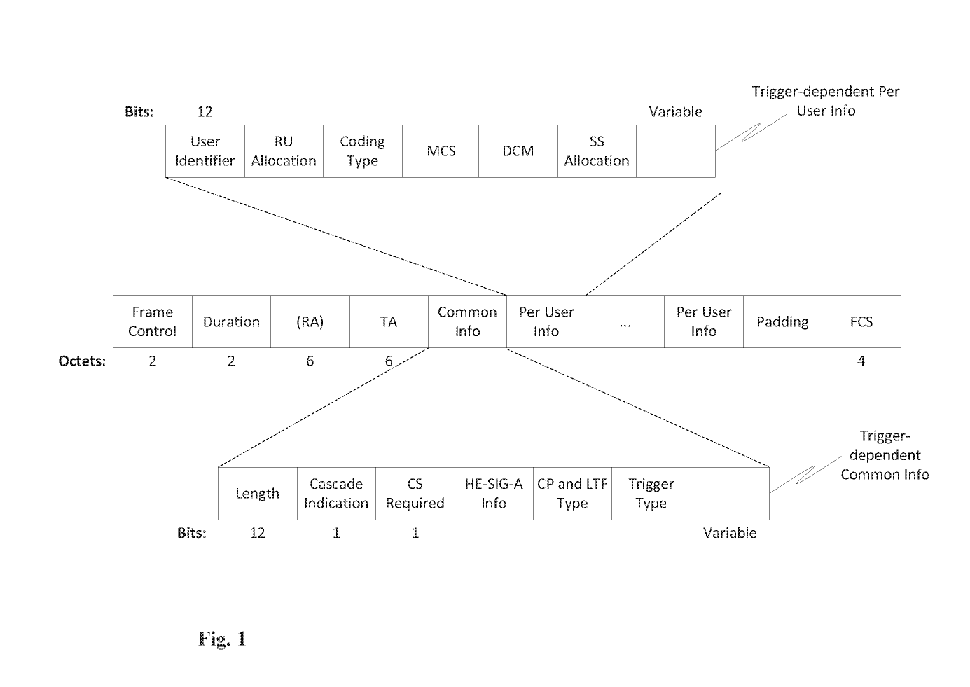

The draft IEEE 802.11ax standard defines trigger-based MU UL OFDMA PPDU (PLPC Protocol Data Unit) transmissions. FIG. 1 illustrates an IEEE 802.11ax Trigger Frame format, which includes a “Common Info” field and “Per User Info” fields for STAs from which the AP can solicit an MU UL transmission at an inter-frame spacing (IFS) time after the Trigger Frame transmission.

One of the main purposes of the Trigger Frame is to solicit a response of MU PPDUs from multiple stations. The Trigger Frame in FIG. 1 further includes the illustrated fields. While certain optional fields with certain lengths in a certain order are shown, it is to be appreciated that the fields, lengths and order can be changed from what is shown. The Trigger frame format includes a frame control field, a duration field, an optional (RA) field (address of STA recipient), TA field (address of STA transmitting the Trigger frame, a Common Info field, one or more per user info fields, a padding field and a FCS (Frame Check Sequence).

The Common Info field includes a length field, a Cascade Information field, a CS Required field, a HE-SIG-A Info field, a CP and LTF Type field a Trigger Type field and a Trigger Dependent Common Info field. The Length subfield of the Common Info field indicates the value of the L-SIG Length field of the HE Trigger-based PPDU that is the response to the Trigger frame. If the Cascade Indication subfield is 1, then a subsequent Trigger frame follows the current Trigger frame. Otherwise the Cascade Indication subfield is 0. The HE-SIG-A Info subfield of the Common Info field indicates the content of the HE-SIG-A field of the HE Trigger-based PPDU response. The number of bits in HE-SIG-A of the HE Trigger-based PPDU which may be implicitly known by all responding STAs can be excluded. The CP and LTF Type subfield of the Common Info field indicates the CP and HE-LTF type of the HE Trigger-based PPDU response. The Trigger Type subfield indicates the type of the Trigger frame. The Trigger frame can include an optional type-specific Common Info and optional type-specific Per User Info.

The Per User information field also includes several optional subfields. Specifically, the Per User Info field includes the User Identifier subfield and indicates the AID (Association ID) of the STA allocated the RU (Resource Unit) to transmit the MPDU(s) in the HE (High Efficiency) Trigger-based PPDU. The RU Allocation subfield of the Per User Info field indicates the RU used by the HE Trigger-based PPDU of the STA identified by User Identifier subfield. The length and coding of RU Allocation subfield are to be determined. The Coding Type subfield of the Per User Info field indicates the code type of the HE Trigger-based PPDU response of the STA identified by User Identifier subfield. The MCS (Modulation and Coding Scheme) subfield of the Per User Info field indicates the MCS of the HE Trigger-based PPDU response of the STA identified by User Identifier field. The DCM subfield of the Per User Info field indicates dual carrier modulation of the HE Trigger-based PPDU response of the STA identified by User Identifier subfield. The SS Allocation subfield of the Per User Info field indicates the spatial streams of the HE Trigger-based PPDU response of the STA identified by User Identifier field.

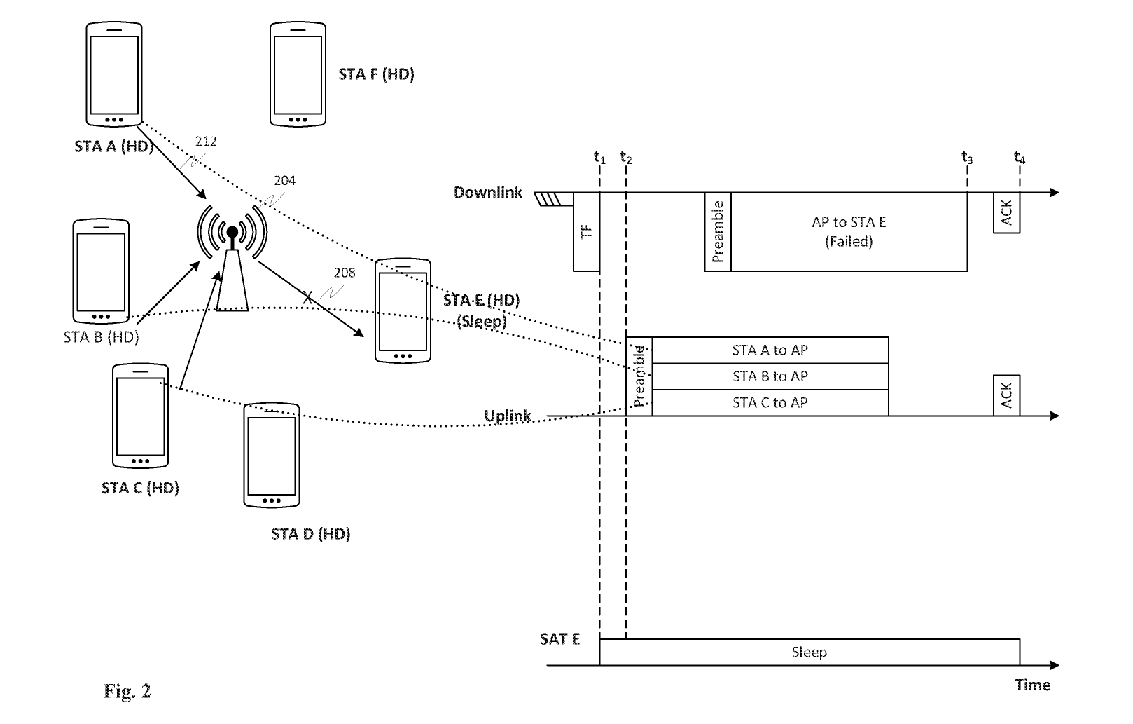

The 802.11ax Trigger Frame conveys information for solicited MU UL OFDM(A) transmission information. A full-duplex-capable AP 204 can initiate another DL frame transmission(s) during the UL transmission 212, as shown in FIG. 2. However, non-UL-solicited STAs (including STA E) may enter low-power sleep state right after a Trigger Frame reception, and thus cannot receive the full-duplex DL transmission from the AP, as shown in FIG. 2 (208). Therefore, to enable OFDMA-based full-duplex communication, the AP needs to explicitly announce both scheduled UL and DL transmission(s) in the Trigger Frame.

In accordance with an exemplary embodiment, the IEEE 802.11ax Trigger Frame solicits multi-user (MU) uplink (UL) OFDMA transmissions. Upon the reception of IEEE 802.11ax Trigger Frame, the non-UL-solicited STA(s) may enter low-power sleep states to save energy, and thus cannot receive the AP's full-duplex DL transmissions. In order to prevent the target full-duplex DL STAs from entering sleep states right after the Trigger Frame reception, an exemplary embodiment modifies the Trigger Frame to include both UL and DL information.

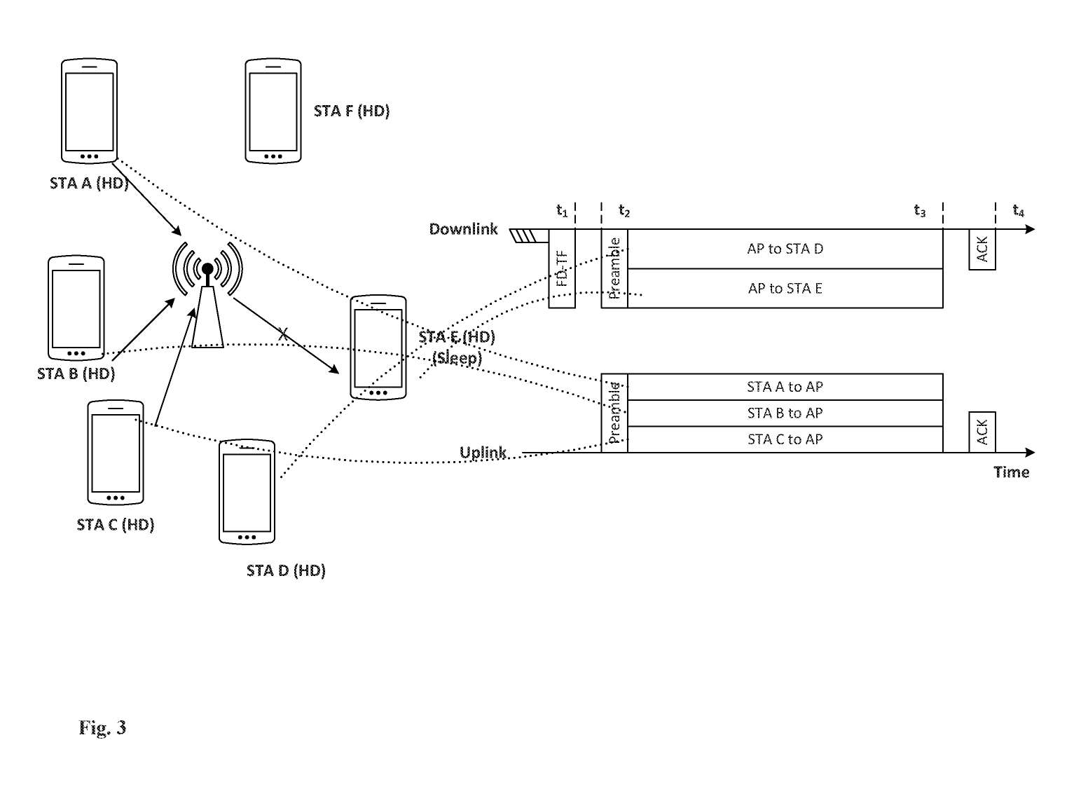

More specifically, an exemplary embodiment discloses a Full-duplex Trigger Frame (FD-TF) which includes not only the UL, but also the scheduled MU DL OFDMA transmission information to enable more efficient full-duplex communications. This inclusion of both UL and DL full-duplex transmission information in the Trigger Frame to solicit simultaneous MU UL and DL OFDMA transmissions prevents the target DL STAs from entering sleep state right after the Trigger Frame, as shown in FIG. 3, and also provides additional performance benefits as summarized herein.

The Trigger frame in IEEE 802.11ax is designed to allocate resources and solicit only MU UL OFDMA transmissions, but it is not designed for full-duplex communications with simultaneous MU UL and DL OFDMA transmissions. An exemplary embodiment further expands the concept and usefulness of the IEEE 802.11ax Trigger Frame so as to make the Trigger Frame more suitable for simultaneous MU UL and DL OFDMA frame transmissions.

An exemplary FD-TF enables various communication scenarios and optimization opportunities, which are not possible with the existing IEEE 802.11ax Trigger Frame. Moreover, based on the information from the FD-TF, the participating UL and DL STAs can further optimize their transmission configuration to avoid inter-STA interference, and non-participating STAs can (i) perform more accurate channel estimation based on full-duplex resource allocation, and/or (ii) enter low-power states for energy efficiency. More details of this behaviour will be described herein.

As mentioned, an exemplary FD-TF also at least brings additional performance benefits:

Enhanced full-duplex transmission configuration: UL STAs can perform further power/BF (Beamforming) optimization based on the DL STA allocation in the FD-TF. This is especially the case when UL STAs have knowledge regarding for example the nulling direction or power back-off estimation for certain DL STAs.

Enhanced power saving operations for 3rd party STAs: Since the exemplary FD-TF can have both UL and DL full-duplex transmission information, the other non-participating STAs can enter a lower power state right after the Trigger Frame until the end of the scheduled full-duplex transmissions without worrying about missing any transmission(s) from the AP.

Enhanced channel/interference estimation: Since the proposed FD-TF can have a detailed resource allocation (e.g., OFDMA sub-channel) for UL and DL transmissions, 3rd party STAs can perform accurate channel/interference measurement. For example, if an OFDMA sub-channel n is allocated only for UL STA m, the other STAs can measure interference from STA m to itself by measuring signals strength on channel n. On the other hand, if an OFDMA sub-channel m is allocated to both UL and DL STAs, then the STAs may not attempt to measure interference on that channel.

The Option for Improved Fine Grain Scheduling.

New Value for “Trigger Type”

An exemplary embodiment defines a new Trigger Type value, i.e., 4 for MU-FD (Multi-User Full-Duplex), in, for example, the “Common Info” field of a Trigger Frame, as shown in Table 1 below. This Trigger Type value, when set to “MU-FD”, indicates that the following “Per User Info” fields include at least one or more elements for MU DL OFDMA transmission information.

TABLE 1
Trigger Type field encoding with full-duplex support.

| Trigger Type Value | Trigger Type Description |
|---|---|
| 0 | Basic Trigger |
| 1 | Beamforming Report Poll |
| | Trigger |
| 2 | MU-BAR |
| 3 | MU-RTS |
| 4 | MU-FD |

New “Per User Info” Field(s) for MU DL OFDMA Transmissions

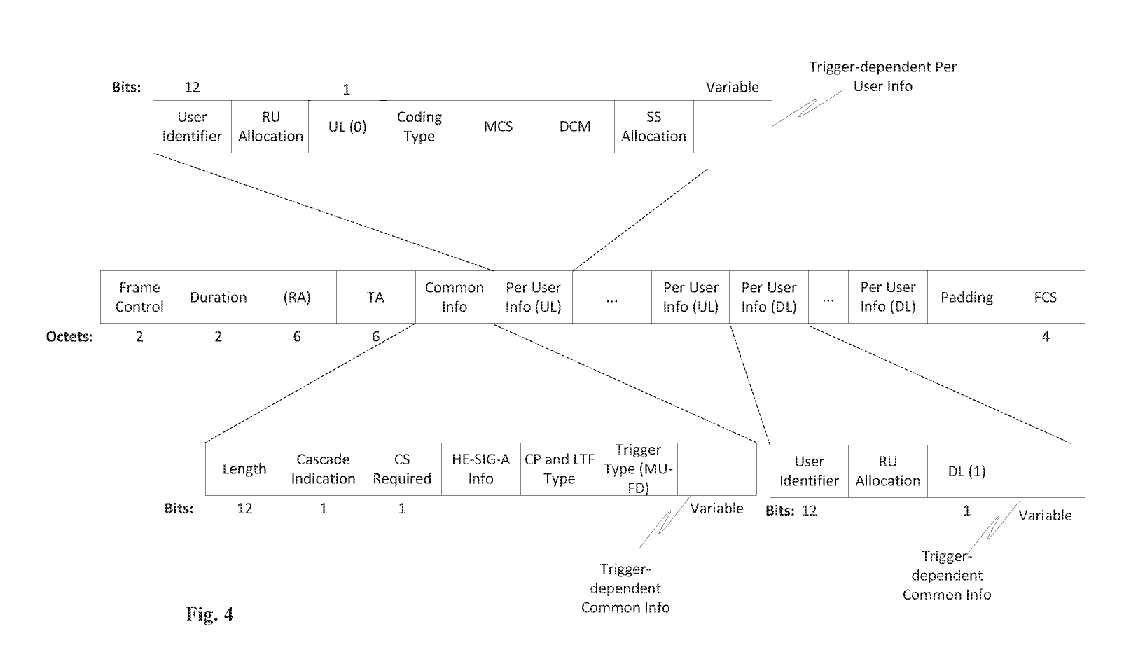

An exemplary embodiment also defines a new one-bit field (e.g., UL/DL field) in the “Per User Info” field for both UL and DL STAs, as shown in FIG. 4. This field can be set to “0” for UL and “1” for DL OFDMA transmissions.

An exemplary embodiment also defines “Per User Info” fields for each MU DL OFDMA transmission, as shown in FIG. 4, which includes information such as the receiver (STA) identifier (e.g., partial AID), RU (resource unit or OFDMA sub-channel) allocation for DL OFDMA transmission, and an indication of the direction of the transmission, i.e., UL (0) or DL (1). Note that the “Per User Info” field for DL transmission may not include all the fields defined for UL transmissions as proposed in the IEEE 802.11ax draft.

For a station with UL and DL full-duplex comparability, FIG. 4 would have the uplink field set as “UL(1)” and the downlink field set as “DL(1).”

Also, for the frame in FIG. 4, there is a Per User Info field for each participating STA, and each device (STA or AP) can be with FD or HD with STA full-duplex capability capable of being handled with the addition of a modified Resource Unit(s).

Exemplary AP Operation:

When soliciting only MU UL OFDMA transmissions for half-duplex operations, the AP does the following:

Sets the Trigger Type value in the “Common Info” field of the Trigger Frame to “Basic Trigger (0)”.

Constructs and includes “Per User Info” fields for UL STAs.

When simultaneously soliciting MU UL and scheduling DL OFDMA transmissions for full-duplex operations, the AP does the following:

Sets the Trigger Type value in the “Common Info” field of the Trigger Frame to “MU-FD (4)”.

Constructs and includes “Per User Info” fields for both UL and DL STAs.

When scheduling only DL OFDMA transmissions for half-duplex operations, the STA does not need to use a Trigger Frame and can send a MU DL OFDMA frame as defined in IEEE 802.11ax

Exemplary STA Operation:

If a Trigger Frame is received, the STA checks the “Trigger Type”

If the “Trigger Type” is ‘MU-FD’, then do the followings; otherwise, follow the normal IEEE 802.11ax procedure.

If a full-duplex Trigger Frame is received (i.e., ‘MU-FD’ type), the STA checks whether it is solicited for UL or scheduled for DL transmissions by examining “User Identifier” in the “Per User Info” fields.

If solicited for UL transmission, then it sends OFDMA PPDU at IFS after the Trigger Frame using configurations specified in the Trigger Frame (e.g., RU allocation, MCS, etc.) Note that the UL STA may check the “Per User Info” fields for DL transmissions and further optimize transmission configurations (e.g., transmit power, MCS (Modulation Coding Scheme), etc.) if desired. For example, STA C in FIG. 3 may reduce its transmit power level to avoid causing interference to STA D, based on “Per User Info” fields in the FD-TF.

If scheduled for DL transmission, then it receives OFDMA PPDU at IFS after the Trigger Frame.

If not solicited for UL nor scheduled for DL transmissions, then it may do the following:

If only UL transmission is scheduled for certain OFDMA sub-channels (e.g., RU1 and RU8 in Table 2), the STA may measure the received signal strengths on the uplink only sub-channels and map them with the signal source (e.g., STA ID) to construct a local interference map, which can be reported to the AP later for future use. Note that such fine-grained channel estimation may require updating for complete compatibility with the IEEE 802.11ax Trigger Frame based full-duplex communications.

The STA may enter a low-power state until the end of OFDMA transmission duration indicated in the FD-TF to save power. For example, a non-FD-participating STA, e.g., STA F in FIG. 3, receives the FD-TF and enters a low-power sleep state for the FD transmission duration from t1 to t4 to reduce power consumption. Note that such FD-TF-based power saving operation may need updating for complete compatibility with the IEEE 802.11.11ax Trigger Frame based full-duplex communications because the full-duplex AP may initiate a DL transmission to non-UL-solicited STAs at any given time during the solicited UL transmissions.

Table 2 below provides a non-limiting example of RU (Resource Unit) allocation for MU UL and DL OFDMA transmission information in an exemplary Trigger Frame:

| | RU1 | RU2 | RU3 | RU4 | RU5 | RU6 | RU7 | RU8 | RU9 |
|---|---|---|---|---|---|---|---|---|---|
| UL | STA F | STA F | STA F | STA H | STA H | | STA G | STA G | STA G |
| DL | | STA A | STA A | STA B | STA C | STA D | STA D | | STA E |

FD increases throughput performance and wireless spectrum efficiency significantly by enabling simultaneous Tx (transmit) and Rx (receive) operations on the same frequency band using self-interference cancellation (SIC) technologies in analog RF circuitry and digital signal processing. Recent advances in SIC technologies make it feasible to enable full-duplex capability at Wi-Fi AP (Access Point) platforms, rendering full-duplex a strong candidate technology for next-generation Wi-Fi (e.g., beyond IEEE 802.11ax) and 5G Wi-Fi systems.

Technologies supporting these advancements aggregate multiple uplink (UL) OFDMA transmissions while a full-duplex-capable AP is transmitting downlink (DL) OFDM(A) transmissions to enhance the spectrum efficiency in full-duplex communications.

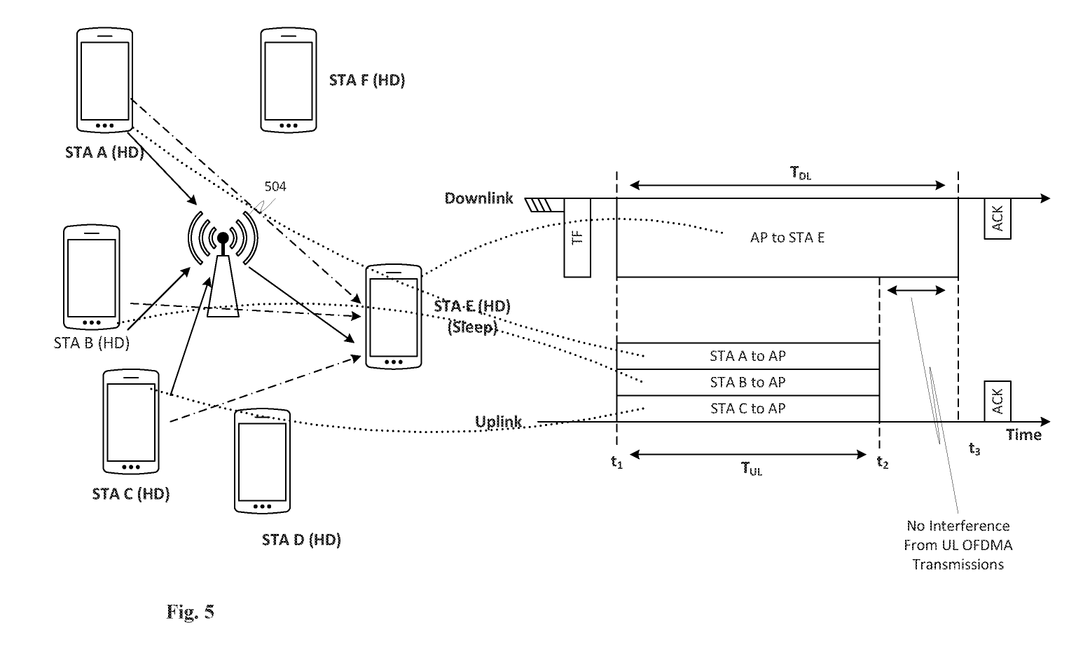

Technologies supporting these advancements also introduce methods for an AP to trigger simultaneous UL and DL OFDMA transmissions by sending a Full-Duplex Trigger Frame (FD-TF). The FD-TF can contain the DL MCS information, which will be determined by the AP based on the level of interference received from UL STAs, amongst other considerations. However, the AP uses the same MCS for the entire duration of the DL A-MPDU transmissions even after the end of UL transmissions, thus wasting spectrum resources, as shown in FIG. 5. Here, the AP 504 sends a Full-Duplex Trigger Frame (FD-TF) to schedule simultaneous full-duplex UL and DL OFDMA transmissions using a fixed MCS for the entire DL A-MPDU transmissions regardless of the presence/absence of the interference from the UL OFDMA transmissions or vice versa.

Another exemplary embodiment is directed toward methods that enables the AP to use different MCSs for A-MPDU sub-frames in order to better utilize wireless spectrum resources and improve throughput performance for full-duplex OFDMA communications.

One exemplary aspect enables a full-duplex-capable AP to use a different MCS for a subset of A-MPDU sub-frame transmissions depending on the presence/absence of interference from multi-user (MU) UL OFMDA transmissions in full-duplex OFDMA communication scenarios, as shown in FIG. 5.

For example, in FIG. 5, the AP may use a lower MCS for the DL transmission (i.e., AP→STA E) from t1 to t2 in order to combat interference from UL STAs, i.e., STAs A, B and C, caused by their UL OFDMA transmissions. However, when the UL STAs complete their transmissions at t2, the AP may be able to use a higher MCS for the DL transmission due to the increased SINR (Signal to Interference plus Noise Ratio) at the DL STA, which may in turn allow the AP to complete the DL transmission earlier than t3. Therefore, by exploiting such asymmetric UL and DL transmission durations and adaptively changing the transmission configurations, e.g., MCS, the AP can better utilize the wireless spectrum and reduce the total transmission time without worrying about the DL performance degradation due to interference from UL transmissions.

A current version of IEEE 802.11ax defines a Trigger Frame that includes MCS information for UL STAs in “Per User Info” field. Each UL STA will use the MCS specified in the Trigger Frame for its entire A-MPDU transmission.

One exemplary embodiment introduces a modified A-MPDU frame format that can indicate MCS per A-MPDU sub-frame per STA for both UL and DL OFDMA transmissions so that the AP (and/or STAs) can use a different MCS per A-MPDU sub-frame on-the-fly based on the presence/absence of the inter-STA interference and other RF/channel environments.

Proposed A-MPDU Frame Format

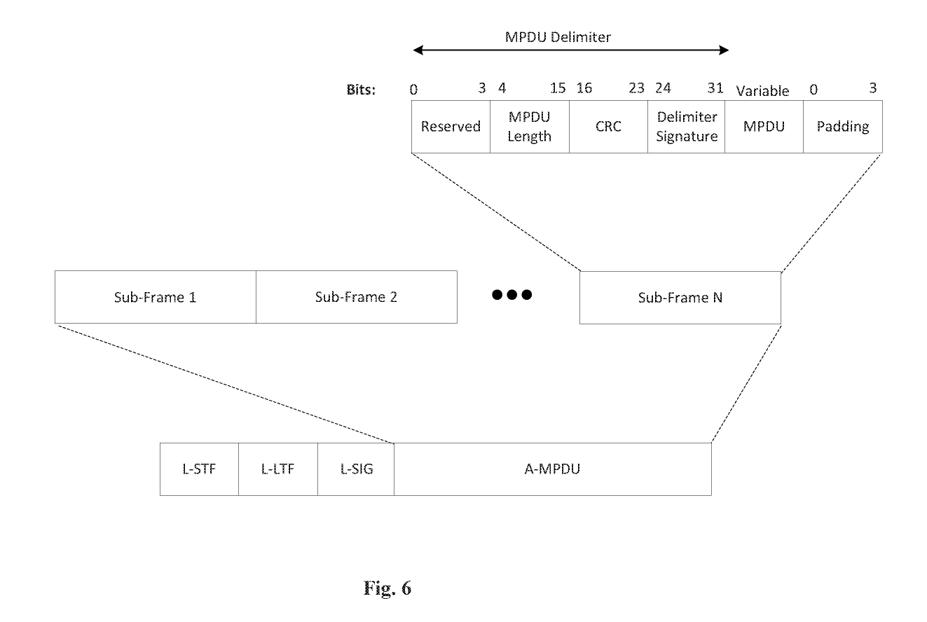

IEEE 802.11n introduced the concept of an aggregated MPDU (A-MPDU) as a viable means to reduce medium access overhead and improve throughput. The main idea of the A-MPDU is to combine multiple MPDU sub-frames within a single frame transmission with a single PHY header, as shown in FIG. 6. The A-MPDU allows the transmitter to selectively re-transmit only the failed MPDUs instead of re-transmitting the entire A-MPDU frame. Each MPDU contains its own MAC header, but the destination address of the aggregated MPDUs must be the same. Upon the receipt of the A-MPDU frame, the receiver will send a block ACK (bitmap) acknowledging correctly received A-MPDU sub-frames. A-MPDU is an efficient way of improving medium access efficiency and throughput performance and its support is mandatory in IEEE 802.11n and IEEE 802.11ac.

In FIG. 6, the conventional IEEE 802.11 A-MPDU frame format is shown. The A-MPDU includes multiple sub-frames and each sub-frame contains the following fields: Reserved (4-bit), MPDU length (12-bit), CRC (8-bit), delimiter signature (8-bit), MPDU (variable length), and padding (0-3 octets depending on MPDU length), as shown in the figure. The MPDU length and delimiter signature information can be used at the receiver to detect and process individual sub-frames.

The RATE field and the LENGTH field in the L-SIG (Legacy SIGNAL) field can be used to indicate the length of the entire A-MPDU frame so that nearby STAs defer their medium access and do not interfere with the A-MPDU frame transmission.

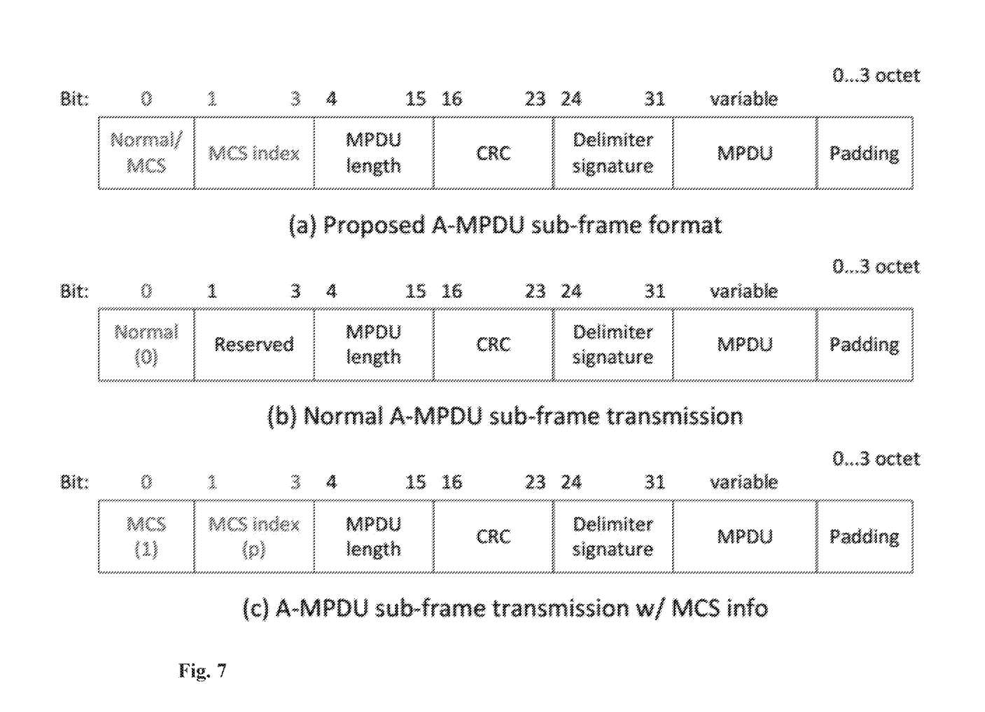

An exemplary embodiment utilizes the Reserved field in the MPDU delimiter of the A-MPDU sub-frame to indicate MCS changes for the following A-MPDU sub-frames, as shown in FIG. 7. The exemplary A-MPDU format introduces a 1-bit field (Bit 0) to indicate whether it conveys the MCS change information followed by a 3-bit field (Bit 1-3) that indicates the MCS index. If the Normal/MCS indication bit (Bit 0) is set to “0 (Normal)”, then the receiver assumes it is a legitimate MPDU frame and processes it; if the bit is set to “1 (MCS)”, then the receiver assumes that the transmitter will use a different MCS indicated in the following “MCS index” field for the following A-MPDU sub-frames and prepares for the frame decoding with the new MCS index.

Note that the proposed A-MPDU sub-frame in FIG. 7 uses the 3 bits “MCS index” field, i.e., it can support up to 2³=8 MCS levels, which might not be sufficient to represent all the available MCS levels. There could be many variants regarding the frame format, including the following:

The 4-bits (Bits 0-3) can be combined to define up to (24-1)=15 MCS levels and the remaining bit representation (e.g., 1111 or 0000) can be used to indicate no MCS change. When the receiver sees such a “no MCS change” value, the receiver can assume no MCS change.

Another option is to use the “MCS index” field in FIG. 7 to indicate the MCS offset (i.e., increase/decrease) from the current MCS level with a predefined step size, e.g., 1 or 2. When the receiver observes a non-zero value in this field, then the receiver will increase or decrease the MCS value correspondingly (e.g., 00 represents no change; 01 means increase by step size x; 10 means decreases by step size x). This technique can be viewed as similar to what is used in an LTE system for TPC (Transmit Power Control) bits.

Exemplary Transmitter Operation

When the AP identifies a full-duplex opportunity, the AP schedules UL and DL OFDM(A) transmissions and trigger simultaneous UL and DL transmissions by sending a Full-Duplex Trigger Frame.

The Full-Duplex Trigger Frame may include MCS index information in the “Per User Info” field of each UL and DL STAs, which is determined by the AP based on inter-STA interference information.

If the AP's solicited UL OFDM(A) transmissions (which might have caused interference at the DL STA(s) before the DL OFDM(A)) end before the end of the DL OFDM(A) transmissions, the AP does the following:

If the UL OFDM(A) transmissions end during the nth DL A-MPDU sub-frame transmission, the AP prepares the nth DL A-MPDU sub-frame including the MCS update information as follows:
Set the “Normal/MCS” field to “1 (MCS)” to indicate the MCS change for the following A-MPDU sub-frame transmissions
Set the “MCS index” field to indicate the new MCS index

Prepare the DL PPDU with A-MPDU sub-frames with the initial MCS index from the 1st to nth A-MPDU sub-frames, and with the updated MCS index from the (n+1)th A-MPDU sub-frames

Transmit the DL PPDU and wait for block ACK from the receiver(s).

Exemplary Receiver Operation

Upon the reception of the A-MPDU frame, the intended receiver (e.g., STA E in FIG. 5) of the A-MPDU does the following.

De-aggregate A-MPDU sub-frames based on MPDU delimiter information (e.g., MPDU length, CRC, delimiter signature, etc.)

For each MPDU sub-frame, check the “Normal/MCS” indication bit, i.e., “0” (Normal)/“1” (MCS)

If set to “0” (Normal MPDU), then proceed to process the MPDU

If set to “1” (MCS update), then
Check the following 3-bit “MCS index” field to identify the updated MCS index used for the following A-MPDU sub-frames
Use the updated MCS index to decode the following A-MPDU sub-frames

At the end of the A-MPDU frame, the receiver prepares and sends a block ACK to the transmitter.

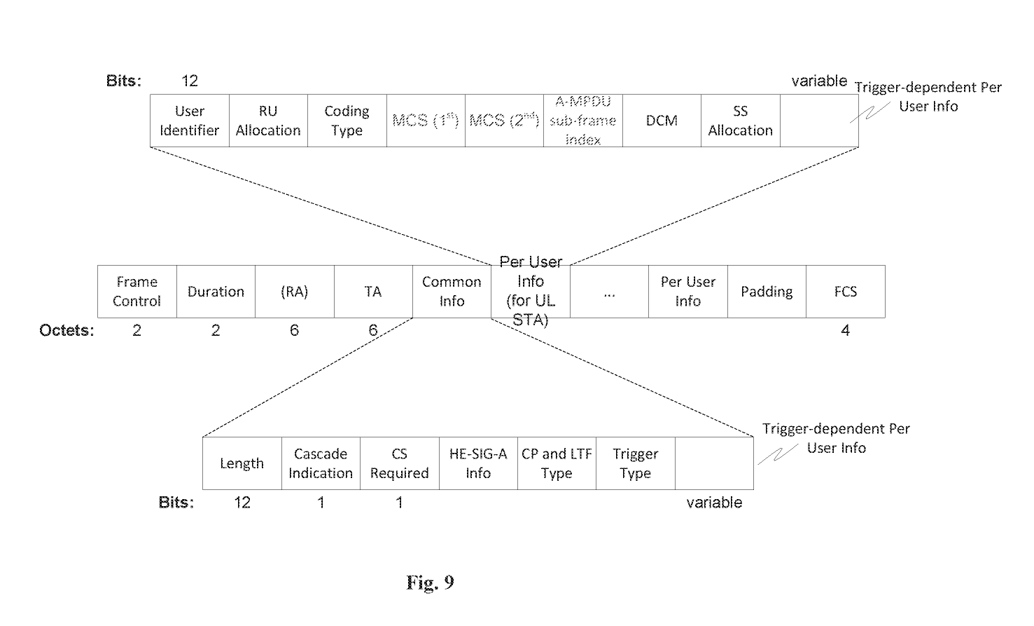

The discussion herein mainly focuses on scenarios where AP's DL OFDM(A) transmissions take longer than STA's UL OFDM(A) transmissions for the ease of presentation, a similar principle can be applied to the opposite scenarios where the UL OFDMA(A) transmissions take longer than the DL OFDM(A) transmissions. For example, the AP can specify both the initial MCS (1st) and updated MCS (2nd) information in the “Per User Info” fields and the A-MPDU sub-frame index from which the UL STA should use the 2nd MCS, as shown in FIG. 9. In this case, the AP may also indicate an updated transmit power level for UL STAs as well if needed (not shown in FIG. 9) in part due to the absence of inter-STA interference constraints after the end of AP's DL OFDM(A) transmissions.

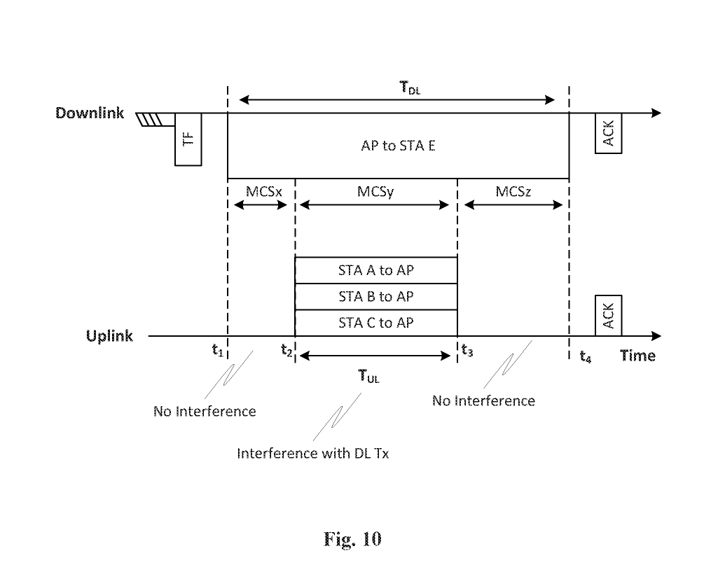

It is to be noted that that there can be one or more MCS changes within/during a single A-MPDU transmission, as shown in FIG. 10. For example, the AP may want to use a higher MCS before the start and after the end of the solicited MU UL OFDMA transmissions, e.g., MCSx=MCSz>MCSy. The frame format in FIG. 9 can be easily extended to include multiple instances of MCS information in such scenarios.

It is also to be noted that while an exemplary embodiment focuses on MCS changes, the proposed principle is generic and can be easily extended to change other transmission configurations, e.g., number of spatial streams, and in general any transmission configuration.

The exemplary technique to define the MCS per A-MPDU sub-frame can be used in other communication scenarios other than asynchronous full-duplex UL/DL transmissions, as shown in FIG. 5. For example, the AP can decide to use different MCSs upon the detection of various events, including changes in RF environment (e.g., interference, early termination of UL transmissions), node mobility (e.g., stationary vs. mobile), implicit/explicit feedback from the receiver, etc., as long as such configuration changes are deemed desirable and expected to introduce additional performance gains and/or overall system/spectrum efficiency.

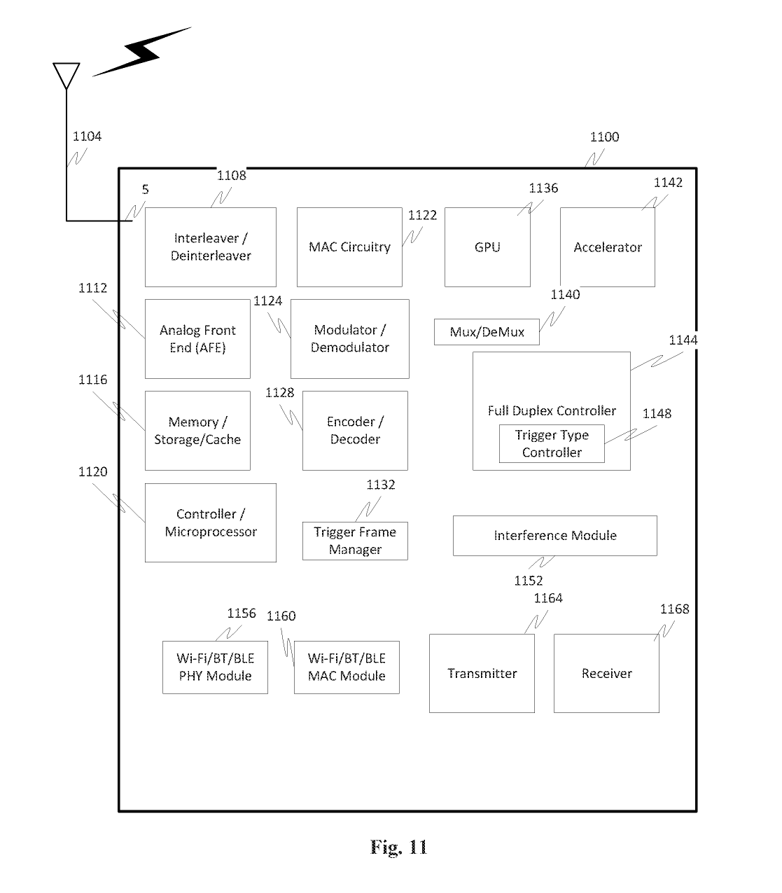

FIG. 11 illustrates an exemplary hardware diagram of a device 1100, such as a wireless device, mobile device, access point, station, and/or the like, that is adapted to implement the technique(s) discussed herein. Operation will be discussed in relation to the components in FIG. 11 appreciating that each separate device, e.g., station, AP, proxy server, etc., in a system, can include one or more of the components shown in the figure, with the components each being optional.

In addition to well-known componentry (which has been omitted for clarity), the device 1100 includes interconnected elements (with links 5 omitted in some instances for clarity) including one or more of: one or more antennas 1104, an interleaver/deinterleaver 1108, an analog front end (AFE) 1112, memory/storage/cache 1116, controller/microprocessor 1120, MAC circuitry 1122, modulator/demodulator 1124, encoder/decoder 1128, trigger frame manager 1132, GPU 1136, accelerator 1142, a multiplexer/demultiplexer 1140, full duplex controller 1144, trigger type controller 1148, interference module 1152, Wi-Fi/BT/BLE PHY module 1156, a Wi-Fi/BT/BLE MAC module 1160, transmitter 1164 and receiver 1168. The various elements in the device 1100 are connected by one or more links (not shown, again for sake of clarity). As one example, the full duplex controller 1144, trigger type controller 1148 and trigger frame manager 1132 can be embodied as a process(es) executing on a processor or controller, such as processor 1120 with the cooperation of the memory 1116. The components could also be embodied as an ASIC and/or as part of a system on a chip.

The device 1100 can have one more antennas 1104, for use in wireless communications such as multi-input multi-output (MIMO) communications, multi-user multi-input multi-output (MU-MIMO) communications Bluetooth®, LTE, RFID, 4G, LTE, etc. The antenna(s) 1104 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 1104 generally interact with the Analog Front End (AFE) 1112, which is needed to enable the correct processing of the received modulated signal and signal conditioning for a transmitted signal. The AFE 1112 can be functionally located between the antenna and a digital baseband system in order to convert the analog signal into a digital signal for processing and vice-versa.

The device 1100 can also include a controller/microprocessor 1120 and a memory/storage/cache 1116. The device 1100 can interact with the memory/storage/cache 716 which may store information and operations necessary for configuring and transmitting or receiving the information described herein. The memory/storage/cache 1116 may also be used in connection with the execution of application programming or instructions by the controller/microprocessor 1120, and for temporary or long term storage of program instructions and/or data. As examples, the memory/storage/cache 1120 may comprise a computer-readable device, RAM, ROM, DRAM, SDRAM, and/or other storage device(s) and media.

The controller/microprocessor 1120 may comprise a general purpose programmable processor or controller for executing application programming or instructions related to the device 1100. Furthermore, the controller/microprocessor 1120 can perform operations for configuring and transmitting information as described herein. The controller/microprocessor 1120 may include multiple processor cores, and/or implement multiple virtual processors. Optionally, the controller/microprocessor 1120 may include multiple physical processors. By way of example, the controller/microprocessor 1120 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 1100 can further include a transmitter 1164 and receiver 1168 which can transmit and receive signals, respectively, to and from other wireless devices and/or access points using the one or more antennas 1104. Included in the device 1100 circuitry is the medium access control or MAC Circuitry 1122. MAC circuitry 1122 provides for controlling access to the wireless medium. In an exemplary embodiment, the MAC circuitry 1122 may be arranged to cooperate with the MAC module 1160 to contend for the wireless medium and configure frames or packets for communicating over the wireless medium.

The PHY Module/Circuitry 1156 controls the electrical and physical specifications for device 1100. In particular, PHY Module/Circuitry 1156 manages the relationship between the device 1100 and a transmission medium. Primary functions and services performed by the physical layer, and in particular the PHY Module/Circuitry 1156, include the establishment and termination of a connection to a communications medium, and participation in the various process and technologies where communication resources shared between, for example, among multiple STAs/APs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 1156 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 1122 handle co-ordination of interactions between the MAC and PHY layers.

The interleaver/deinterleaver 1108 cooperates with the various PHY components to provide Forward Error correction capabilities. The modulator/demodulator 1124 similarly cooperates with the various PHY components to perform modulation which in general is a process of varying one or more properties of a periodic waveform, referred to and known as a carrier signal, with a modulating signal that typically contains information for transmission. The encoder/decoder 1128 manages the encoding/decoding used with the various transmission and reception elements in device 1100.

The MAC layer and components, and in particular the MAC module 1160 and MAC circuitry 1122 provide functional and procedural means to transfer data between network entities and to detect and possibly correct errors that may occur in the physical layer. The MAC module 1160 and MAC circuitry 1122 also provide access to contention-based and contention-free traffic on different types of physical layers, such as when multiple communications technologies are incorporated into the device 1100. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 1100 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 1142 can cooperate with MAC circuitry 1122 to, for example, perform real-time MAC functions. The GPU 1136 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In operation, the device 1100 and in particular the full duplex controller 1144 and trigger type controller determine whether the MU UL is half or full duplex and perform the associated features as discussed herein. As discussed, the trigger type controller 1148 can set the trigger type value in the Common Info field with the trigger frame manager capable of constructing and including information in the Per User Info field(s) as outlined above.

Acting as a receiver, the device 100 and in particular the trigger frame manager 1132 and trigger type controller 1148 can check the trigger type as sent by an AP and one of: send an OFDMA PPDU at IFS after Trigger Frame with the cooperation of the transmitter 1164, receive OFDM(A) PPDU at IFS after a Trigger Frame with the cooperation of the receiver 1168, develop an interference map with the cooperation of the interference module 1152, or enter, with the cooperation of processor 1120, enter a low power mode or state.

Optionally, the device 1100 operates such that when the AP identifies a full-duplex opportunity, the AP schedules UL and DL OFDM(A) transmissions and trigger simultaneous UL and DL transmissions by sending a Full-Duplex Trigger Frame with the cooperation of the full duplex controller 1144.

The Full-Duplex Trigger Frame, managed by the trigger frame manager 1132, may include MCS index information in the “Per User Info” field of each UL and DL STAs, which is determined by the AP based on inter-STA interference information. If the AP's solicited UL OFDM(A) transmissions (which might have caused interference at the DL STA(s) before the DL OFDM(A)) end before the end of the DL OFDM(A) transmissions, the AP performs the steps outlined above in relation to setting the MCS field, setting the MCS field index and preparing the DL PPDU with A-MPDU sub-frames with the initial MCS index from the 1st to nth A-MPDU sub-frames, and with the updated MCS index from the (n+1)th A-MPDU sub-frames. The transmitter 1164 can then transmit the DL PPDU and wait for block ACK from the receiver(s).

When a device receives the A-MPDU frame with the cooperation of receiver 1168, the intended receiver (e.g., STA E in FIG. 5) of the A-MPDU does the following.

The device 1100 de-aggregates A-MPDU sub-frames based on MPDU delimiter information (e.g., MPDU length, CRC, delimiter signature, etc.) For each MPDU sub-frame, the trigger frame manager 1132 checks the “Normal/MCS” indication bit, i.e., “0” (Normal)/“1” (MCS) and if set to “0” (Normal MPDU), then processes the MPDU. If set to “1” (MCS update), then the trigger frame manager 1132 checks the following 3-bit “MCS index” field to identify the updated MCS index used for the following A-MPDU sub-frames and uses the updated MCS index to decode the following A-MPDU sub-frames. At the end of the A-MPDU frame, the receiver 1168 prepares and sends a block ACK to the transmitter.

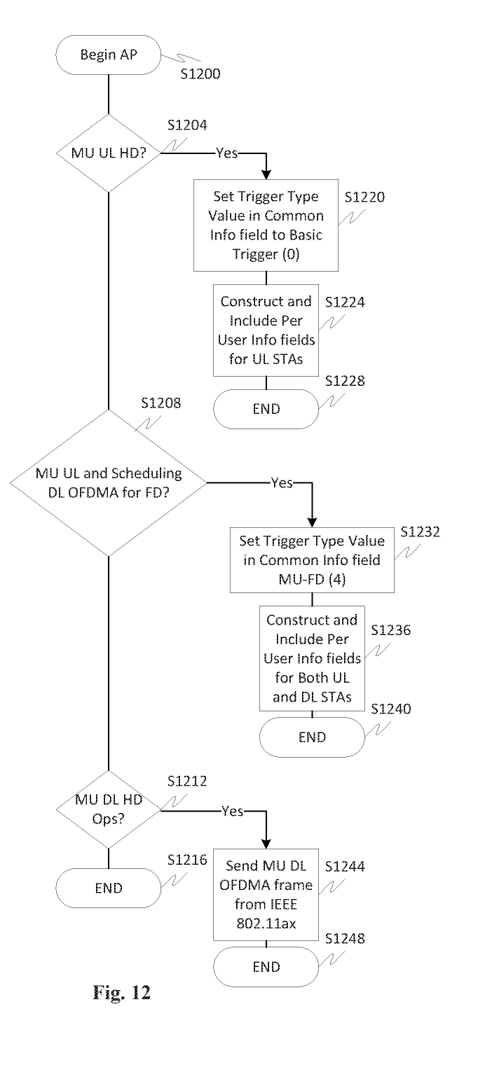

FIG. 12 illustrates exemplary AP/transmitter operation with control beginning in step S1200 and continuing to step S1204. In step S1204, and when soliciting only MU UL OFDMA transmissions for half-duplex operations, the AP does the following:

In step S1220 sets the Trigger Type value in the “Common Info” field of the Trigger Frame to “Basic Trigger (0)”, and

In step S1224 constructs and includes “Per User Info” fields for UL STAs with control continuing to step S1228 where the control sequence ends.

In step S1208, and when simultaneously soliciting MU UL and scheduling DL OFDMA transmissions for full-duplex operations, control continues to step S1232 with the AP performing the following:

In step S1232 sets the Trigger Type value in the “Common Info” field of the Trigger Frame to “MU-FD (4)”,

In step S1236 constructs and includes “Per User Info” fields for both UL and DL STAs with control continuing to step S1240 where the control sequence ends.

In step S1212, and when scheduling only DL OFDMA transmissions for half-duplex operations, the STA does not need to use a Trigger Frame and can send (in step S1244) a MU DL OFDMA frame as defined in IEEE 802.11ax. Control then continues to step S1248 where the control sequence ends.

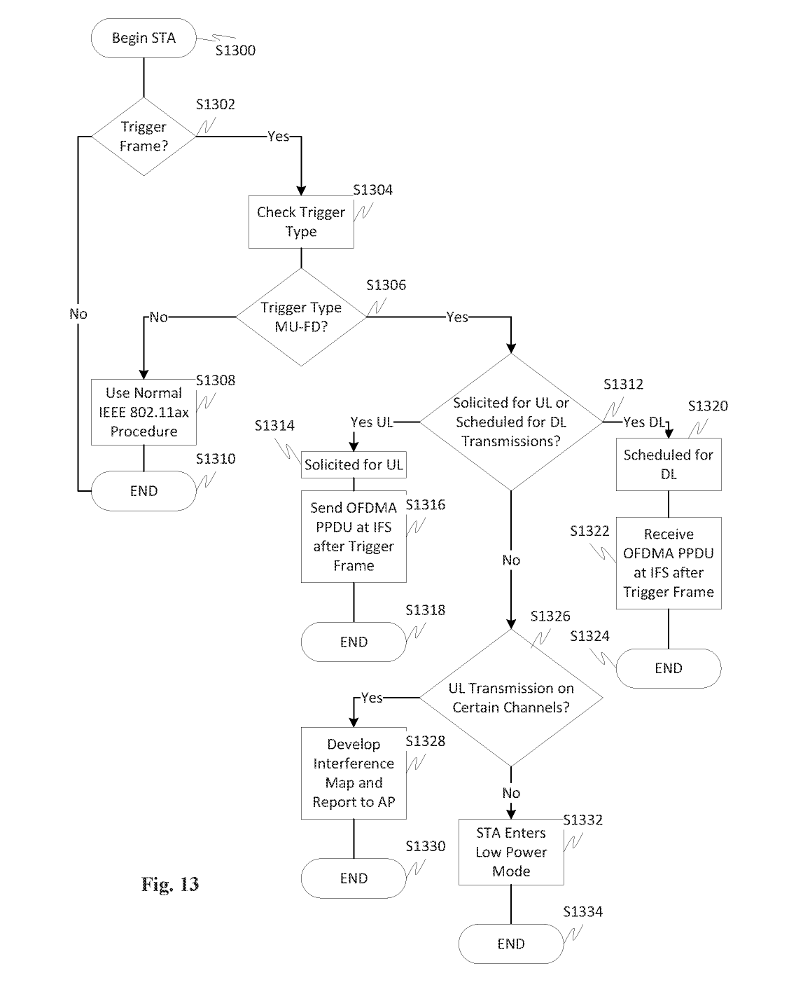

FIG. 13 illustrates exemplary STA/receiver operation with control beginning in step S1300 and continuing to step S1302. In step S1302, and if a Trigger Frame is received, in step S1304 the STA checks the “Trigger Type”. If the “Trigger Type” in step S1304-1306 is ‘MU-FD’, then the STA performs steps S1312-S1134. Otherwise, the STA follows the normal IEEE 802.11ax procedure in steps S1308 and S1310.

In step S1306, and if a full-duplex Trigger Frame is received (i.e., ‘MU-FD’ type), the STA in step S1312 checks whether the STA is solicited for UL or scheduled for DL transmissions by examining “User Identifier” in the “Per User Info” fields.

If solicited for UL transmission, in step S1314, then the STA in step S1316 sends OFDMA PPDU at IFS after the Trigger Frame using configurations specified in the Trigger Frame (e.g., RU allocation, MCS, etc.) Note that the UL STA may check the “Per User Info” fields for DL transmissions and further optimize transmission configurations (e.g., transmit power, MCS (Modulation and Coding Scheme), etc.) if desired. For example, STA C in FIG. 3 may reduce its transmit power level to avoid causing interference to STA D, based on “Per User Info” fields in the FD-TF.

If, in step S1320 it is determined that the STA is scheduled for DL transmission, then the STA in step S1322 receives OFDMA PPDU at IFS after the Trigger Frame.

If not solicited for UL nor scheduled for DL transmissions, then control continues to step S1326 and the STA may do the following:

If only UL transmission is scheduled for certain sub-channels (e.g., RU1 and RU8 in Table 2), control continues to step S1328 where the STA may measure the received signal strengths on the uplink only sub-channels and map them with the signal source (e.g., STA ID) to construct a local interference map, which can be reported to the AP later for future use. Note that such fine-grained channel estimation may require updating for complete compatibility with the IEEE 802.11ax Trigger Frame based full-duplex communications.

Alternatively, in step S1332, the STA may enter a low-power state until the end of OFDMA transmission duration indicated in the FD-TF to save power. For example, a non-FD-participating STA, e.g., STA F in FIG. 3, receives the FD-TF and enters a low-power sleep state for the FD transmission duration from t1 to t4 to reduce power consumption. Note that such FD-TF-based power saving operation may need updating for complete compatibility with the IEEE 802.11.11ax Trigger Frame based full-duplex communications because the full-duplex AP may initiate a DL transmission to non-UL-solicited STAs at any given time during the solicited UL transmissions.

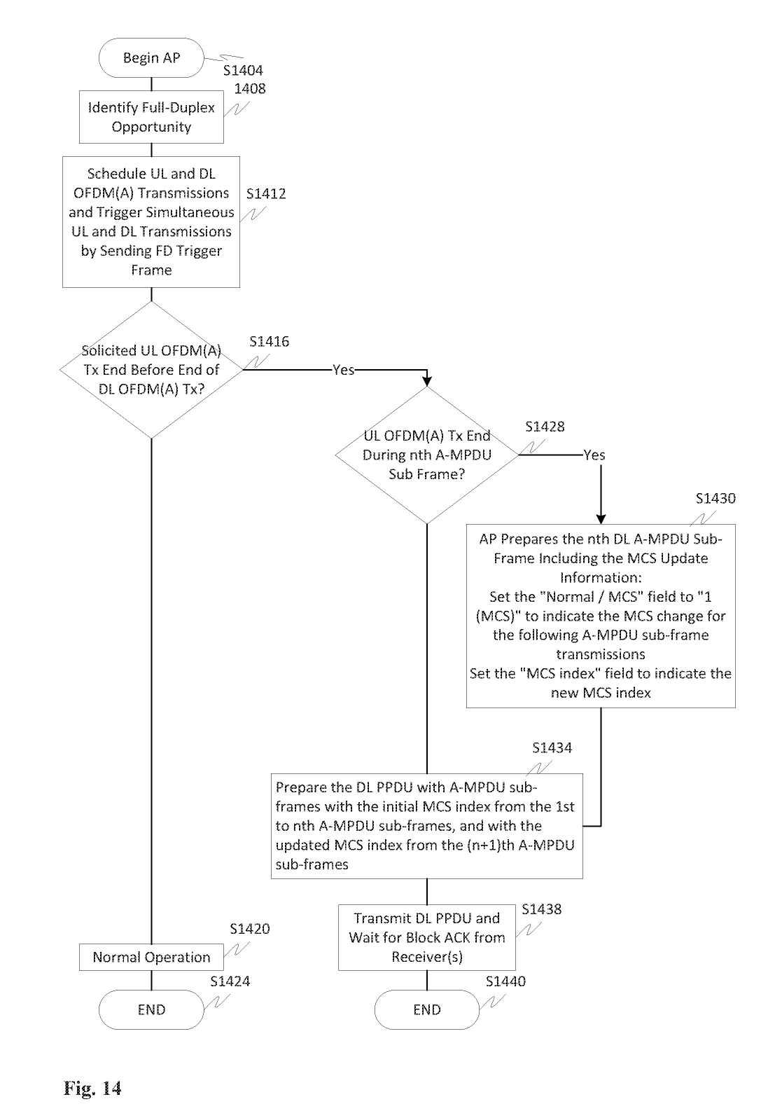

FIG. 14 illustrates exemplary AP/transmitter operation with control beginning in step S1404 and continuing to step S1408 where the AP identifies a full-duplex opportunity. Next, in step S1412, the AP schedules UL and DL OFDM(A) transmissions and triggers simultaneous UL and DL transmissions by sending a Full-Duplex Trigger Frame. The Full-Duplex Trigger Frame may include MCS index information in the “Per User Info” field of each UL and DL STAs, which is determined by the AP based on inter-STA interference information.

Then, in step S1416, a determination is made whether the AP's solicited UL OFDM(A) transmissions (which might have caused interference at the DL STA(s) before the DL OFDM(A)) end before the end of the DL OFDM(A) transmissions. When they do, control continues to step S1428 with control otherwise continuing normally in step S1420 with the control sequence ending in step S1424.

In step S1428, the AP makes a determination whether the UL OFDM(A) transmissions end during the nth DL A-MPDU sub-frame transmission and if so control continues to step S1430 where the AP prepares the nth DL A-MPDU sub-frame including the MCS update information as follows:

Set the “Normal/MCS” field to “1 (MCS)” to indicate the MCS change for the following A-MPDU sub-frame transmissions

Set the “MCS index” field to indicate the new MCS index. Control then continues to step S1434.

In step S1434, the AP prepares the DL PPDU with A-MPDU sub-frames with the initial MCS index from the 1st to nth A-MPDU sub-frames, and with the updated MCS index from the (n+1)th A-MPDU sub-frames. Then, in step S1438, the AP transmits the DL PPDU and waits for a block ACK from the receiver(s).

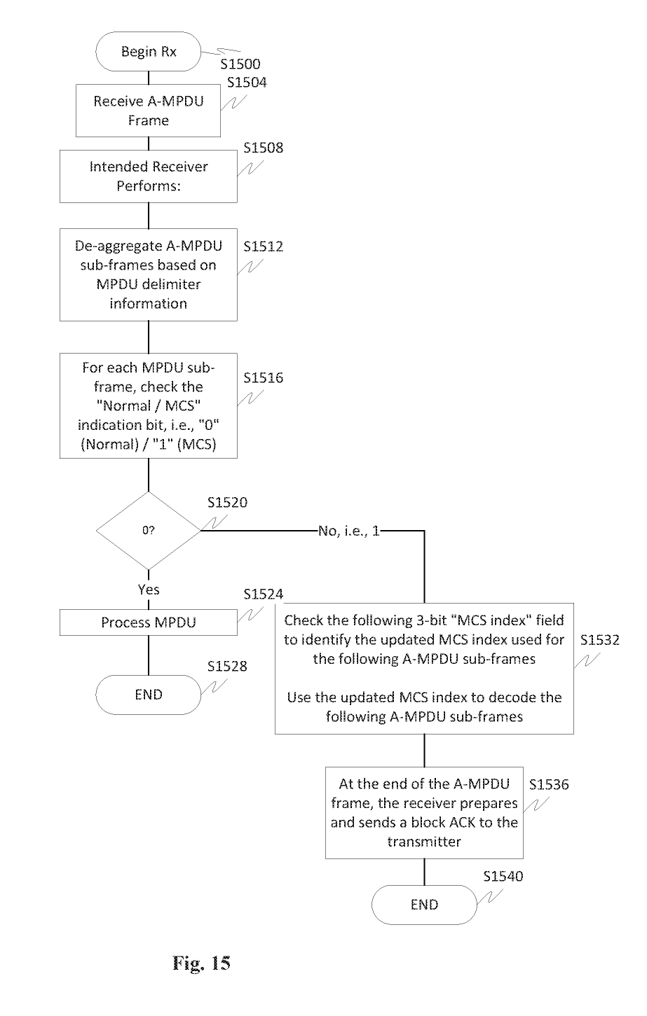

FIG. 15 illustrates exemplary STA/receiver operation with control beginning in step S1500 and continuing to step S1504. In step S1504 and upon the reception of the A-MPDU frame, the intended receiver (e.g., STA E in FIG. 5) of the A-MPDU in step S1508 transitions to performing the following.

In step S1512 the receiver de-aggregates A-MPDU sub-frames based on MPDU delimiter information (e.g., MPDU length, CRC, delimiter signature, etc.). Next, in step S1516 and for each MPDU sub-frame, the receiver checks the “Normal/MCS” indication bit, i.e., “0” (Normal)/“1” (MCS).

If set to “0” (Normal MPDU), then control proceeds to step S1524 to process the MPDU with control continuing to step S1528 where the control sequence ends.

If set to “1” (MCS update) then control jumps to step S1532. In step S1532, the receiver checks the following 3-bit “MCS index” field to identify the updated MCS index used for the following A-MPDU sub-frames and uses the updated MCS index to decode the following A-MPDU sub-frames. Next, in step S1536 and at the end of the A-MPDU frame, the receiver prepares and sends a block ACK to the transmitter with control continuing to step S1540.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a full duplex controller and connected processor to control full or half duplex operation of the wireless communication device; and

a trigger frame manager that announces both scheduled uplink and downlink transmission(s) in a Trigger Frame sent by a transmitter to a station.

Any of the above aspects, wherein a trigger type value is specified in a Common Info field.
Any of the above aspects, wherein when operating in multi-user uplink and scheduled downlink, Per User Info fields are included in the Trigger Frame for both uplink and downlink stations.
Any of the above aspects, wherein when operating in multi-user uplink half-duplex, Per User Info fields are included in the Trigger Frame for uplink stations.
Any of the above aspects, wherein a Modulation and Coding Scheme (MCS) is changed for certain A-MPDU sub-frame transmissions.
Any of the above aspects, wherein a Modulation and Coding Scheme field indicates an updated MCS index.
Any of the above aspects, wherein a downlink protocol data unit includes two or more varying MCSs for different A-MPDU sub-frames.
Any of the above aspects, wherein simultaneous uplink and downlink transmissions are scheduled by the Trigger Frame.
Any of the above aspects, wherein the Trigger Frame includes a Common Info field and a plurality of Per User Uplink and Per User Downlink fields.
Any of the above aspects, wherein a modified A-MPDU sub-frame includes an indication of normal or updated MCS and a MCS index.
A non-transitory information storage media having stored thereon one or more instructions, that when executed by one or more processors, cause a wireless device to perform a method comprising:
controlling full or half duplex operation; and

announcing both scheduled uplink and downlink transmission(s) in a Trigger Frame sent by a transmitter to a station.

Any of the above aspects, wherein a trigger type value is specified in a Common Info field.
Any of the above aspects, wherein when operating in multi-user uplink and scheduled downlink, Per User Info fields are included in the Trigger Frame for both uplink and downlink stations.
Any of the above aspects, wherein when operating in multi-user uplink half-duplex, Per User Info fields are included in the Trigger Frame for uplink stations.
Any of the above aspects, wherein a Modulation and Coding Scheme (MCS) is changed for certain A-MPDU sub-frame transmissions.
Any of the above aspects, wherein a Modulation and Coding Scheme field indicates an updated MCS index.
Any of the above aspects, wherein a downlink protocol data unit includes two or more varying MCSs for different A-MPDU sub-frames.
Any of the above aspects, wherein simultaneous uplink and downlink transmissions are scheduled by the Trigger Frame.
Any of the above aspects, wherein the Trigger Frame includes a Common Info field and a plurality of Per User Uplink and Per User Downlink fields.
A wireless communications device comprising:
means for controlling full or half duplex operation; and
means for announcing both scheduled uplink and downlink transmission(s) in a Trigger Frame sent by a transmitter to a station.
Any of the above aspects, wherein a trigger type value is specified in a Common Info field.
Any of the above aspects, wherein when operating in multi-user uplink and scheduled downlink, Per User Info fields are included in the Trigger Frame for both uplink and downlink stations.
Any of the above aspects, wherein when operating in multi-user uplink half-duplex, Per User Info fields are included in the Trigger Frame for uplink stations.
Any of the above aspects, wherein a Modulation and Coding Scheme (MCS) is changed for certain A-MPDU sub-frame transmissions.
Any of the above aspects, wherein a Modulation and Coding Scheme field indicates an updated MCS index.
Any of the above aspects, wherein a downlink protocol data unit with two or more varying MCSs for different A-MPDU sub-frames.
Any of the above aspects, wherein simultaneous uplink and downlink transmissions are scheduled by the Trigger Frame.
Any of the above aspects, wherein the Trigger Frame includes a Common Info field and a plurality of Per User Uplink and Per User Downlink fields.
Any of the above aspects, wherein a modified A-MPDU sub-frame includes an indication of normal or updated MCS and a MCS index.
A wireless communications device comprising:

a receiver to receive a trigger frame;

a trigger frame manager to check a trigger type in the trigger frame;
a full-duplex controller to establish, based on the trigger type, multi-user full-duplex operation and determine whether the device is solicited for uplink or scheduled for downlink transmissions.
Any of the above aspects, wherein when solicited for uplink the device sends an OFDMA PPDU at an Inter-Frame Spacing after the trigger frame.
Any of the above aspects, wherein when scheduled for downlink the device receives at a receiver an OFDMA PPDU at an Inter-Frame Spacing after the trigger frame.
Any of the above aspects, wherein the full-duplex controller further determines whether there are uplink transmissions on certain channels and either develops an interference map or enters a low power mode.
Any of the above aspects, wherein a Modulation and Coding Scheme (MCS) is checked to determine if multiple MCSs are being used.
Any of the above aspects, wherein a Modulation and Coding Scheme field indicates an updated MCS index.
Any of the above aspects, wherein a downlink protocol data unit includes two or more varying MCSs for different A-MPDU sub-frames.
Any of the above aspects, wherein simultaneous uplink and downlink transmissions are scheduled by the Trigger Frame.
Any of the above aspects, wherein the Trigger Frame includes a Common Info field and a plurality of Per User Uplink and Per User Downlink fields.
Any of the above aspects, wherein a modified A-MPDU sub-frame includes an indication of normal or updated MCS and a MCS index.
A wireless communications device comprising:

means for receiving a trigger frame;

means for checking a trigger type in the trigger frame;
means for establishing, based on the trigger type, multi-user full-duplex operation and determining whether the device is solicited for uplink or scheduled for downlink transmissions.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, circuitry, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a full duplex controller and connected processor to control full or half duplex operation of the wireless communication device; and
a trigger frame manager that announces both scheduled uplink and downlink transmission(s) in a Trigger Frame sent by a transmitter to a station.

2. The device of claim 1, wherein a trigger type value is specified in a Common Info field.

3. The device of claim 1, wherein when operating in multi-user uplink and scheduled downlink, Per User Info fields are included in the Trigger Frame for both uplink and downlink stations.

4. The device of claim 1, wherein when operating in multi-user uplink half-duplex, Per User Info fields are included in the Trigger Frame for uplink stations.

5. The device of claim 1, wherein a Modulation and Coding Scheme (MCS) is changed for certain A-MPDU sub-frame transmissions.

6. The device of claim 5, wherein a Modulation and Coding Scheme field indicates an updated MCS index.

7. The device of claim 5, wherein a downlink protocol data unit with two or more varying MCSs for different A-MPDU sub-frames.

8. The device of claim 5, wherein simultaneous uplink and downlink transmissions are scheduled by the Trigger Frame.

9. The device of claim 5, wherein the Trigger Frame includes a Common Info field and a plurality of Per User Uplink and Per User Downlink fields.

10. The device of claim 5, wherein a modified A-MPDU sub-frame includes an indication of normal or updated MCS and a MCS index.

11. A non-transitory information storage media having stored thereon one or more instructions, that when executed by one or more processors, cause a wireless device to perform a method comprising:
controlling full or half duplex operation; and
announcing both scheduled uplink and downlink transmission(s) in a Trigger Frame sent by a transmitter to a station.

12. The media of claim 11, wherein a trigger type value is specified in a Common Info field.

13. The media of claim 11, wherein when operating in multi-user uplink and scheduled downlink, Per User Info fields are included in the Trigger Frame for both uplink and downlink stations.

14. The media of claim 11, wherein when operating in multi-user uplink half-duplex, Per User Info fields are included in the Trigger Frame for uplink stations.

15. The media of claim 11, wherein a Modulation and Coding Scheme (MCS) is changed for certain A-MPDU sub-frame transmissions.

16. The media of claim 15, wherein a Modulation and Coding Scheme field indicates an updated MCS index.

17. The media of claim 15, wherein a downlink protocol data unit with two or more varying MCSs for different A-MPDU sub-frames.

18. The media of claim 15, wherein simultaneous uplink and downlink transmissions are scheduled by the Trigger Frame.

19. The media of claim 15, wherein the Trigger Frame includes a Common Info field and a plurality of Per User Uplink and Per User Downlink fields.

20. A wireless communications device comprising:
means for controlling full or half duplex operation; and
means for announcing both scheduled uplink and downlink transmission(s) in a Trigger Frame sent by a transmitter to a station.
